(19) United States
(12) Patent Application Publication
(10) Pub. No.: US 2019/0094007 A1
(43) Pub. Date: Mar. 28, 2019

(54) CURVATURE RADIUS MEASURER, ELECTRONIC DEVICE AND METHOD OF MANUFACTURING CURVATURE RADIUS MEASURER

(71) Applicant: SHENZHEN NEW DEGREE TECHNOLOGY CO., LTD., Shenzhen (CN)

(72) Inventors: Hao LI, Shenzhen (CN); Tuoxia HUANG, Shenzhen (CN)

(21) Appl. No.: 16/200,044

(22) Filed: Nov. 26, 2018

Related U.S. Application Data
(63) Continuation-in-part of application No. PCT/CN2016/083554, filed on May 26, 2016.

(51) Int. Cl. G01B 7/293; G01B 7/16; G01L 9/02

(52) U.S. Cl. CPC G01B 7/293; G01N 2203/0023; G01L 9/02; G01B 7/20

(57) ABSTRACT

A curvature radius measurer, an electronic device and a manufacturing method for the curvature radius measurer are provided. The curvature radius measurer is adhered to a panel. When the panel is pressed, the panel can be bent and deformed, and strain sensing resistors are deformed therewith, thus causing change of electrical characteristics of a curvature radius measurement circuit. The electrical property is only determined by the curvature radius of the panel, and the corresponding electric signal is obtained through the curvature radius measurement circuit, that is, the curvature radius of the panel at a pressed position can be accurately detected.

### CROSS-REFERENCES TO RELATED APPLICATION

This application is a continuation-in-part of pending International Application No. PCT/CN2016/083554 with an international filing date of May 26, 2016 designating the US. The contents of the aforementioned application, including any intervening amendments thereto, are incorporated herein by reference in their entirety.

### TECHNICAL FIELD

The present disclosure relates to the technical field of curvature radius measurement, and particularly relates to a curvature radius measurer, an electronic device and a method of manufacturing curvature radius measurer.

### BACKGROUND

The curvature radius measurer in the prior art generally uses an optical measuring instrument to amplify the measured object, the test position and zoom of the piece to be measured may be adjusted in the computer, and the curvature radius can be measured. All data is processed by the computer, measurement data and image graphics can be output, and the measurement is accurate. However, the existing curvature radius measurer is difficult to be applied to an electronic device or the like, and the curvature radius measurement can be performed only when the measured object is placed on the optical measuring instrument, which is inconvenient to use and high in cost.

### SUMMARY

One object of some embodiments of the present disclosure is to provide a curvature radius measurer to solve the technical problem that the existing curvature radius measuring device needs to place the object to be measured on an optical measuring instrument, which is inconvenient to use.

It is achieved as follows. A curvature radius measurer comprising a substrate adhered to a panel and a curvature radius measuring circuit disposed on the substrate, the substrate has a first mounting surface and a second mounting surface disposed opposite to each other, the curvature radius measuring circuit has at least two resistors formed on the substrate, at least one of the resistors is a first strain sensing resistor disposed on the first mounting surface and configured to measure the strain value of the first mounting surface, at least one of the resistors is a second strain sensing resistor disposed on the second mounting surface and configured to measure the strain value of the second mounting surface, and the resistors of the curvature radius measuring circuit are adjacently distributed.

In one embodiment, one said curvature radius measuring circuit having at least two resistors is a voltage dividing circuit formed by one said first strain sensing resistor and one said second strain sensing resistor connected in series; or

one said curvature radius measuring circuit having at least two resistors is a shunt circuit formed by one said first strain sensing resistor and one said second strain sensing resistor connected in parallel; or

one said curvature radius measuring circuit having at least two resistors is a series-connected constant current circuit formed by one said first strain sensing resistor and one said second strain sensing resistor connected in series; or

one said curvature radius measuring circuit having two resistors is a parallel-connected constant voltage circuit formed by one said first strain sensing resistor and one said second strain sensing resistor connected in parallel.

In one embodiment, two of the resistors of one said curvature radius measuring circuit are placed coincide with each other across the thickness of said substrate; or

two of the resistors of one said curvature radius measuring circuit are staggeredly placed.

In one embodiment, one said curvature radius measuring circuit has four resistors and is a half bridge circuit formed by one said first strain sensing resistor, one said second strain sensing resistor and two reference resistors which are electrically connected; or

one said curvature radius measurer has four resistors and includes a third strain sensing resistor disposed on the second mounting surface and configured to measure the strain value of the second mounting surface and a fourth strain sensing resistor disposed on the first mounting surface and configured to measure the strain value of the first mounting surface, wherein the curvature radius measuring circuit is a full bridge circuit formed by one said first strain sensing resistor, one said second strain sensing resistor, one said third strain sensing resistor and one said fourth strain sensing resistor which are electrically connected.

In one embodiment, two of the four resistors of one said curvature radius measuring circuit coincide with the other two of the four resistors are placed in a one-to-one correspondence across the thickness of said substrate; or

the four resistors of one said curvature radius measuring circuit are staggeredly placed.

In one embodiment, the curvature radius measurer comprises at least two said curvature radius measuring circuits which are distributed in an array on the substrate; or

the curvature radius measurer comprises at least two said curvature radius measuring circuits which are distributed in a circular shape on the substrate.

In one embodiment, the substrate has a thickness ranging from 0.03 mm to 5 mm.

In one embodiment, the substrate comprises a base and a circuit layer disposed on the base.

In one embodiment, the base is a plastic base, a glass base, a metal base or a composite base.

In one embodiment, the resistor is a resistor formed by printing, a resistor formed by coating, or a resistor formed by printing and having a polymer coating with pressure sensing property or a sintered piezoelectric ceramic coating.

An embodiment of the present disclosure provides an electronic device which comprises a panel, a curvature radius measurer, and a curvature radius detecting circuit electrically connected to the curvature radius measurer, wherein the substrate is adhered on the panel.

In one embodiment, the substrate and the panel are adhered to each other by glue.

In one embodiment, the glue is UV glue, AB glue, 502 glue, double-sided glue or foam glue.

An embodiment of the present disclosure provides a method of manufacturing a curvature radius measurer, comprising the steps of:

S₁) providing the substrate;

S₂) forming at least two resistors on the substrate, at least one of the resistors being the first strain sensing resistor disposed on the first mounting surface and at least one of the resistors being the second strain sensing resistor disposed on the second mounting surface; and

S₃) electrically connecting the resistors to form a curvature radius measuring circuit.

In an embodiment, the curvature radius measuring circuit is formed as a voltage dividing circuit by connecting one said first strain sensing resistor in series with one said second strain sensing resistor; or

the curvature radius measuring circuit is formed as a shunt circuit by parallel connecting one said first strain sensing resistor in parallel with one said second strain sensing resistor; or

the curvature radius measuring circuit is formed as a series-connected constant current circuit by connecting one said first strain sensing resistor and one in series with second strain sensing resistor; or

the curvature radius measuring circuit is formed as a parallel-connected constant voltage circuit by parallel connecting one said first strain sensing resistor in parallel with one said second strain sensing resistor, or

the curvature radius measuring circuit is formed as a half bridge circuit by electrically connecting one said first strain sensing resistors, one said second strain sensing resistor and two reference resistors; or

the method in one embodiment comprises forming a third strain sensing resistor on the second mounting surface, forming a fourth strain sensing resistor on the first mounting surface, and forming the curvature radius measuring circuit as a full bridge circuit by electrically connecting one said first strain sensing resistor, one said second strain sensing resistor, one said third strain sensing resistor and one said fourth strain sensing resistor.

In some embodiments of the present disclosure, the curvature radius measurer is adhered to the panel, and when the panel is pressed, the panel is bent and deformed, and the strain sensing resistors are deformed following the deformation of the panel, thereby causing the change of the electrical characteristics of the curvature radius measuring circuit. The electrical characteristics are only determined by the curvature radius of the panel. The curvature radius of the panel at the pressed position can be accurately detected by obtaining the corresponding electrical signal through the curvature radius measurement circuit. The curvature radius measurer can be easily manufactured and assembled, the inconvenient use caused due to the need to place the object to be measured on the existing optical measuring instrument can be avoided, and the interference caused by different glue adhesive conditions can be avoided. Therefore, the curvature radius measurer has good stability and repeatability. When the curvature radius of the panel is far greater than the thickness of the substrate, the detection is reliable and the thickness of the substrate can be as small as 0.1 mm. In some cases of micro-deformation, the curvature radius of the panel is generally greater than 1000 mm, so the curvature radius measurer is very suitable for detecting micro-deformation. The curvature radius measurer is small in thickness, is suitable for mobile phones, computers and other electronic products with high thickness requirements and is used as a pressure sensing sensor. It is also suitable for household appliances and is used as a pressure button. It is also applicable to any panel having a curvature change and is used to detect changes in the curvature radius of the panel or to detect changes in the cause of changes in the curvature radius.

### BRIEF DESCRIPTION OF THE DRAWINGS

FIG. 1 is a schematic structural view of a curvature radius measurer according to an embodiment of the present disclosure;

FIG. 2 is a schematic structural view of the curvature radius measurer of FIG. 1 when pressed;

FIG. 3 is a schematic structural view of the curvature radius measurer of FIG. 1 applied to a panel;

FIG. 4 is a schematic structural view of the curvature radius measurer and the panel in FIG. 3 which are connected to each other via hard glue;

FIG. 5 is a schematic structural view of the curvature radius measurer and the panel of FIG. 3 which are connected to each other via soft glue;

FIG. 6 shows a curvature radius measuring circuit applied in a curvature radius measurer according to a first embodiment of the present disclosure;

FIG. 7 shows a curvature radius measuring circuit applied in a curvature radius measurer according to a second embodiment of the present disclosure;

FIG. 8 shows a curvature radius measuring circuit applied in a curvature radius measurer according to a third embodiment of the present disclosure;

FIG. 9 shows a curvature radius measuring circuit applied in a curvature radius measurer according to a fourth embodiment of the present disclosure;

FIG. 10 shows a schematic structural view of a curvature radius measurer according to a fifth embodiment of the present disclosure;

FIG. 11 is a schematic structural view of the curvature radius measurer of FIG. 10 when pressed;

FIG. 12 shows a curvature radius measuring circuit applied in the curvature radius measurer of FIG. 10;

FIG. 13 is a schematic structural view of a curvature radius measurer according to a sixth embodiment of the present disclosure;

FIG. 14 is a schematic structural view of the curvature radius measurer of FIG. 13 when pressed; and

FIG. 15 shows a curvature radius measuring circuit applied in the curvature radius measurer of FIG. 13.

### DETAILED DESCRIPTION OF THE EMBODIMENTS

In order to make the objects, technical solutions and advantages of the present disclosure more clear, the present disclosure will be further described in detail below with reference to the accompanying drawings and embodiments. It should be understandable that the specific embodiments described herein are merely illustrative of the present disclosure and are not intended to limit the present disclosure.

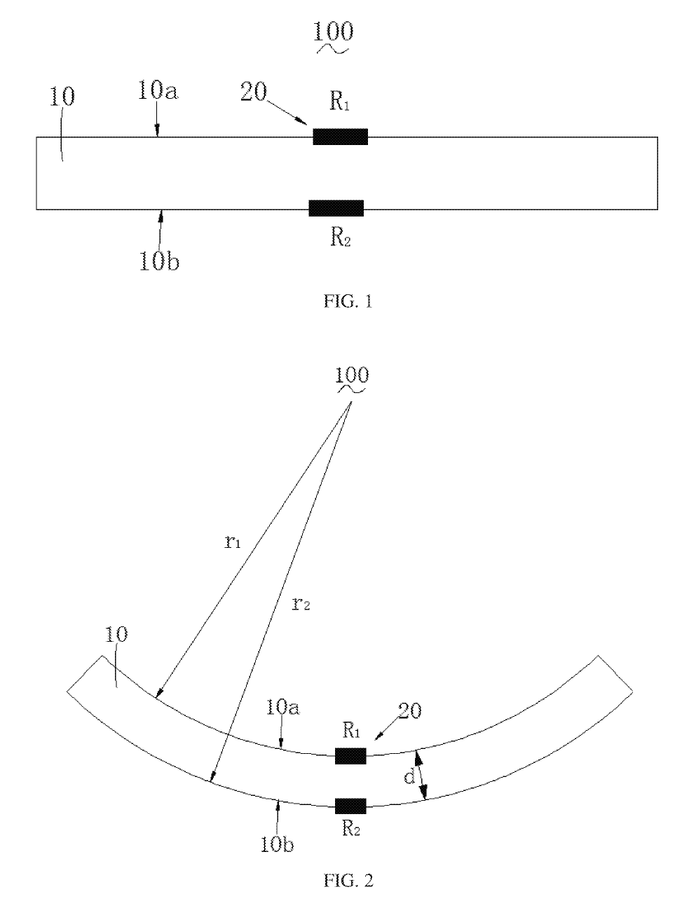

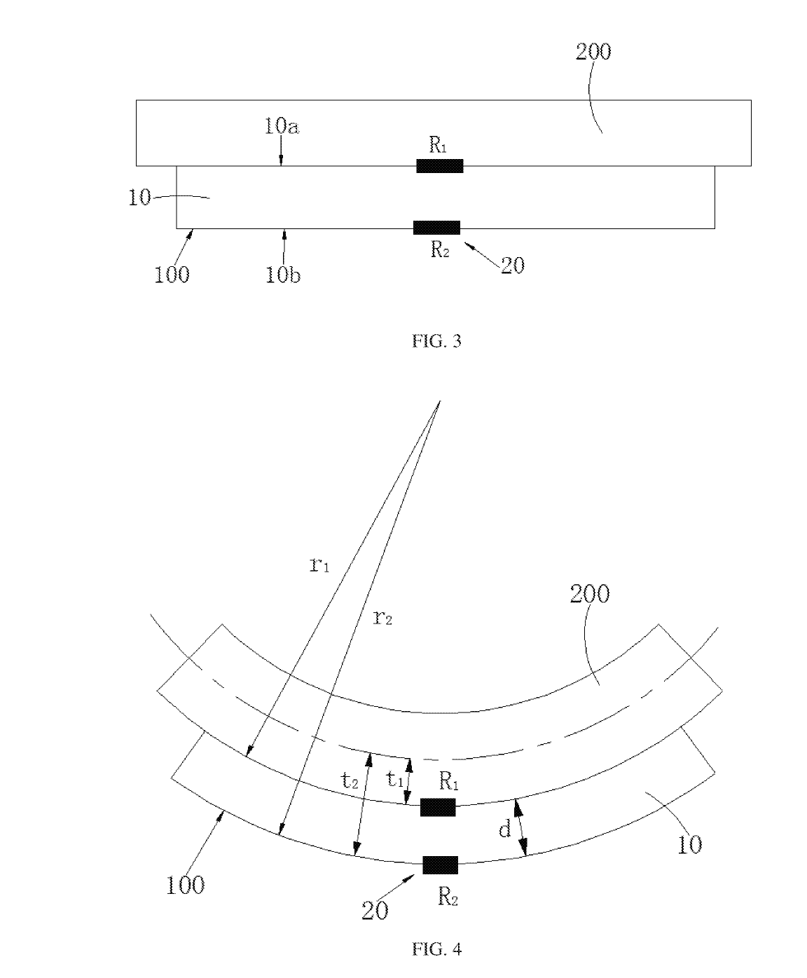

Referring to FIG. 1 to FIG. 3, a curvature radius measurer 100 according to a first embodiment of the present disclosure includes a substrate 10 adhered to a panel 200 and a curvature radius measuring circuit 20 disposed on the substrate 10. The substrate 10 has a first mounting surface 10a and a second mounting surface 10b disposed opposite to each other. The curvature radius measuring circuit 20 has at least two resistors formed on the substrate 10. At least one resistor is a first strain sensing resistor R1 disposed on the first mounting surface 10a and configured to measure the strain value of the first mounting surface 10a. At least one resistor is a second strain sensing resistor R2 disposed on the second mounting surface 10b and configured to measure the strain value of the second mounting surface 10b. The resistors in the curvature radius measuring circuit 20 are adjacently distributed.

The curvature radius measurer 100 is adhered on the panel 200. When the panel 200 is pressed, the panel 200 is bent and deformed, and the strain sensing resistors are also deformed following the deformation of the panel, causing a change in the electrical characteristics of the curvature radius measuring circuit 20, which is only determined by the curvature radius of the panel 200. By obtaining the corresponding electrical signal by the curvature radius measuring circuit 20, the curvature radius of the panel 200 at the pressed position can be accurately detected. The curvature radius measurer 100 can be easily manufactured and assembled, the inconvenient use caused due to the need to place the object to be measured on the existing optical measuring instrument can be avoided, and the interference caused by different glue adhesive conditions can be avoided. Therefore, the curvature radius measurer has good stability and repeatability. When the curvature radius of the panel is far greater than the thickness of the substrate, the detection is reliable and the thickness of the substrate 10 can be as small as 0.1 mm. In some cases of micro-deformation, the curvature radius of the panel 200 is generally greater than 1000 mm, so the curvature radius measurer 100 is very suitable for detecting micro-deformation. The curvature radius measurer is small in thickness, suitable for mobile phones, computers and other electronic products with high thickness requirements and is used as a pressure sensing sensor. It is also suitable for household appliances and is used as a pressure button. It is also applicable to any panel 200 having a curvature change and is used to detect changes in the curvature radius of the panel 200 or to detect changes in the cause of changes in the curvature radius.

In one embodiment, a curvature radius measuring circuit 20 has two resistors, and the curvature radius measuring circuit 20 is a voltage dividing circuit formed by a first strain sensing resistor R₁ and a second strain sensing resistor R₂ connected in series.

The panel is simplified as a one-dimensional beam structure, and the substrate is adhered to the panel. When the strain sensing resistor generates strain under the action of force, the strain value of the strain sensing resistor and the resistance value are related to each other by the pressure variation coefficient. R₀ and R₁ are respectively the initial and changed resistance values of the strain sensing resistor, e is the strain value of the strain sensing resistor, and GF is the pressure variation coefficient. Below is their relationship:

R₁=R₀(1+εGF)

Referring to FIG. 4, in the first case which is an ideal situation, the curvature radius measurer 100 and the panel 200 are connected by hard glue (i.e., completely rigid glue), and when the panel 200 is pressed, the substrate 10 is deformed following the deformation of the panel 200. The first strain sensing resistor R₁ may represent the strain value of the first mounting surface 10a, and the second strain sensing resistor R₂ may represent the strain value of the second mounting surface 10b. The thickness of the glue is ignored, and the deformation neutral line is on the panel 200.

The following are known:

the strain value at the first strain sensing resistor R₁ is

$${ɛ}_{1} = \frac{{t}_{1}}{{r}_{1}} ;$$

the initial resistance value of the strain sensing resistor R₁ is R₁;

the strain value at the second strain sensing resistor R₂ is

$${ɛ}_{2} = \frac{{t}_{2}}{{r}_{2}} ;$$

and

the initial resistance value of the strain sensing resistor R₂ is R₂;

where t₁ and r₁ are respectively the distance between the first strain sensing resistor R₁ and the deformation neutral line and the curvature radius at the first strain sensing resistor R₁, and t₂ and r₂ are respectively the distance between the second strain sensing resistor R₂ and the deformation neutral line and the curvature radius at the second strain sensing resistor R₂.

The first strain sensing resistor R₁ and the second strain sensing resistor R₂ have the same initial resistance value, that is,

R₁=R₂=R₀

In this case, d=r₂−r₁

where d is the thickness of the substrate 10.

The following is a process simplifying the strain values at the first strain sensing resistor R₁ and the second strain sensing resistor R₂.

$$∵ {ɛ}_{1} = \frac{{t}_{1}}{{r}_{1}} , {ɛ}_{2} = \frac{{t}_{2}}{{r}_{2}} = \frac{{t}_{2}}{{r}_{1} + d}$$

$$also ∵ {r}_{1} , {r}_{2} << d \\ ∴ {r}_{1} \approx {r}_{2} = r \\ ∴ {ɛ}_{1} \approx \frac{{t}_{1}}{r} , {ɛ}_{2} \approx \frac{{t}_{2}}{r}$$

Also referring to FIG. 4, a voltage divider circuit is formed and a constant voltage source is used. The input voltage U₀ is applied across the circuit, and the voltage U across the first strain sensing resistor R₁ is measured. Below is input and output voltage formula.

$$\begin{matrix}U = \frac{{R}_{1}}{{R}_{1} + {R}_{2}} {U}_{0} = \frac{{R}_{0} ( 1 + {ɛ}_{1} GF )}{{R}_{0} ( 1 + {ɛ}_{1} GF ) + {R}_{0} ( 1 + {ɛ}_{2} GF )} {U}_{0} \\ = \frac{1 + \frac{{t}_{1}}{r} GF}{2 + \frac{{t}_{1}}{r} GF + \frac{{t}_{2}}{r} GF} {U}_{0} = \frac{r + {t}_{1} GF}{2 r + {t}_{1} GF + {t}_{2} GF} {U}_{0}\end{matrix} \\ ∵ {t}_{2} - {t}_{1} = d \\ ∴ U = \frac{r + {t}_{1} GF}{2 r + {t}_{1} GF + {t}_{2} GF} {U}_{0} = \frac{r + {t}_{1} GF}{2 ( r + {t}_{1} GF ) + dGF} {U}_{0} = \frac{1}{2 + \frac{d}{\frac{r}{GF} + {t}_{1}}} {U}_{0} \\ ∵ {t}_{1} << \frac{r}{GF} ∴ \frac{d}{\frac{r}{GF} + {t}_{1}} \approx \frac{d}{r} GF \\ ∴ U \approx \frac{1}{2 + \frac{d}{r} GF} {U}_{0}$$

Therefore, the output voltage U is only determined by the curvature radius r at the first strain sensing resistor R₁. When the panel 200 is pressed, the curvature radius measuring circuit 20 obtains the output voltage U across the first strain sensing resistor R₁, and the curvature radius r at the first strain sensing resistor R₁ can be accordingly determined.

Referring to FIG. 5, in the second case which is an ideal situation, the curvature radius measurer 100 and the panel 200 are connected by soft glue (i.e., fully flexible glue). When the panel 200 is pressed, the substrate 10 is deformed following the deformation of the panel 200. The first strain sensing resistor R₁ can represent the strain value of the first mounting surface 10a, and the second strain sensing resistor R₂ can represent the strain value of the second mounting surface 10b. The thickness of the glue is ignored and the deformation neutral line is on the substrate 10.

The following are known:

The strain value at the first strain sensing resistor R₁ is

$${ɛ}_{1} = - \frac{{t}_{1}}{{r}_{1}} ;$$

The initial resistance value of the strain sensing resistor R₁ is R₁;

The strain value at the second strain sensing resistor R₂ is

$${ɛ}_{2} = \frac{{t}_{2}}{{r}_{2}} ;$$

The initial resistance value of the strain sensing resistor R₂ is R₂;

where t₁ and r₁ are respectively the distance between the first strain sensing resistor R₁ and the deformation neutral line and the curvature radius at the first strain sensing resistor R₁, and t₂ and r₂ are respectively the distance between the 20 second strain sensing resistor R₂ and the deformation neutral line and the curvature radius at the second strain sensing resistor R₂.

The first strain sensing resistor R₁ and the second strain sensing resistor R₂ have the same initial resistance value, that is,

R₁=R₂=R₀

In this case, d=r₂−r₁

where d is the thickness of the substrate 10.

The following is a process simplifying the strain values at the first strain sensing resistor R₁ and the second strain sensing resistor R₂.

$$∵ {ɛ}_{1} = - \frac{{t}_{1}}{{r}_{1}} , {ɛ}_{2} = \frac{{t}_{2}}{{r}_{2}} = \frac{{t}_{2}}{{r}_{1} + d} \\ also ∵ {r}_{1} , {r}_{2} << d ∴ {r}_{1} \approx {r}_{2} = r \\ ∴ {ɛ}_{1} \approx - \frac{{t}_{1}}{r} , {ɛ}_{2} \approx \frac{{t}_{2}}{r}$$

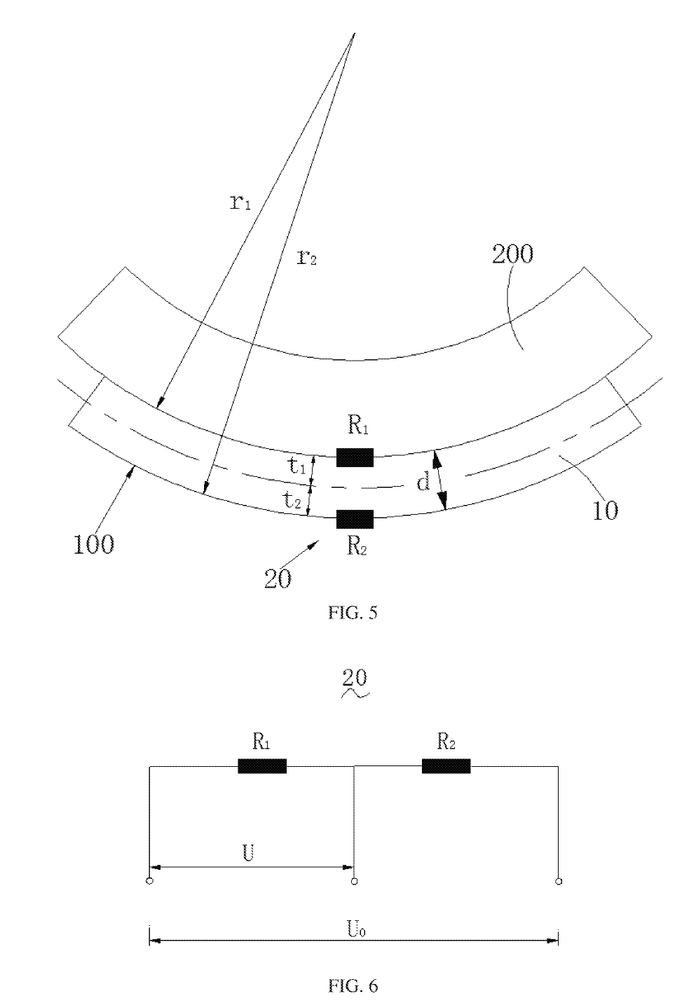

Also referring to FIG. 6, a voltage divider circuit is formed and a constant voltage source is used. The input voltage U₀ is applied across the circuit, and the voltage U across the first strain sensing resistor R₁ is measured. Below is input and output voltage formula.

$$\begin{matrix}U = \frac{{R}_{1}}{{R}_{1} + {R}_{2}} {U}_{0} = \frac{{R}_{0} ( 1 + {ɛ}_{1} GF )}{{R}_{0} ( 1 + {ɛ}_{1} GF ) + {R}_{0} ( 1 + {ɛ}_{2} GF )} {U}_{0} \\ = \frac{1 - \frac{{t}_{1}}{r} GF}{2 - \frac{{t}_{1}}{r} GF + \frac{{t}_{2}}{r} GF} {U}_{0} = \frac{r - {t}_{1} GF}{2 r - {t}_{1} GF + {t}_{2} GF} {U}_{0}\end{matrix} \\ ∵ {t}_{1} + {t}_{2} = d$$

$$\begin{matrix}∴ U = \frac{r - {t}_{1} GF}{2 r - {t}_{1} GF + {t}_{2} GF} {U}_{0} = \frac{r - {t}_{1} GF}{2 r - {t}_{1} GF + dGF} {U}_{0} \\ = \frac{r - {t}_{1} GF}{2 ( r - {t}_{1} GF ) + dGF} {U}_{0} = \frac{1}{2 + \frac{dGF}{r - {t}_{1} GF}} {U}_{0} \\ = \frac{1}{2 ° \frac{d}{\frac{r}{GF} - {t}_{1}}} {U}_{0}\end{matrix} \\ ∵ {t}_{1} << \frac{r}{GF} ∴ \frac{d}{\frac{r}{GF} - {t}_{1}} \approx \frac{d}{r} GF \\ ∴ U \approx \frac{1}{2 + \frac{d}{r} GF} {U}_{0}$$

Therefore, the output voltage U is only determined by the curvature radius r at the first strain sensing resistor R₁. When the panel 200 is pressed, the curvature radius measuring circuit 20 obtains the output voltage U across the first strain sensing resistor R₁, and the curvature radius r at the first strain sensing resistor R₁ can be accordingly determined.

The third case is an actual situation. The rigidity of the glue is between the hard glue in the first case and the soft glue in the second case. The rigidity of the glue determines the position of the deformation neutral line, and thus determines t₁ and t₂. In the first case and the second case the output voltages U are the same, that is, the rigidity of the glue has no influence on the voltage U across the first strain sensing resistor R₁, so the voltage U across the first strain sensing resistor R₁ is determined only by the pressure variation coefficient GF, the thickness d of the substrate 10 and the curvature radius r. As the pressure variation coefficient GF and the thickness d of the substrate 10 are fixed values, the voltage U across the first strain sensing resistor R₁ is directly determined by the curvature radius r. Meanwhile, the resistance value of the strain sensing resistor is in one-to-one correspondence with the strain value, and the change of the strain value can be converted into the change of the resistance value of the strain sensing resistor. The curvature radius measuring circuit 20 outputs the voltage U across the first strain sensing resistor R₁ and the curvature radius of the panel 200 when it is pressed can be accordingly obtained.

Simplifying the panel as a one-dimensional beam structure may be a special case. In the following, the general case will be considered, that is, the panel is regarded as a two-dimensional planar structure, and the curvature radius measurer can be applied to a two-dimensional planar structure to determine the curvature radius of the panel when it is pressed into a spherical surface.

The panel is regarded as a two-dimensional planar structure, and the substrate is adhered to the panel. When the strain sensing resistor generates strain under the action of force, the strain value of the strain sensing resistor and the resistance value are related to each other by the pressure variation coefficient. R₀ and R₁ are respectively the initial and changed resistance values of the strain sensing resistor, ε is the strain value of the strain sensing resistor. The strain value ε of the strain sensing resistor may be divided into the strain values εx and εy in two directions, and GF is the pressure variation coefficient. Below is their relationship:

$$\begin{matrix}{R}_{1} = {R}_{0} ( 1 + {ɛ}_{1 x} \cdot GF ) ( 1 + {ɛ}_{1 y} \cdot GF ) \\ = {R}_{0} ( 1 + {ɛ}_{1 x} \cdot GF + {ɛ}_{1 y} \cdot GF + {ɛ}_{1 x} \cdot {ɛ}_{1 y} \cdot {GF}^{2} ) ;\end{matrix}$$

where ε₁ₓ·ε_{1y}·GF² is very small and may be ignored.

Thus R₁=R₀(1+ε₁ₓ·GF+ε_{1y}·GF),

and ε₁ₓ=t₁ₓ/rₓ, ε_{1y}=t_{1y}/r_{y},

t₁ₓ=t_{1y}=t₁,

r_{y}≈k·rₓ

where k is the aspect ratio of the panel, which should be partial differential but can be approximated as a proportional relationship.

Therefore, R₁=R₀(1+GF·t₁/rₓ+GF·t₁/krₓ).

It should be understood that the voltage U across the first strain sensing resistor R₁ is also related only to the aspect ratio k of the panel, the pressure variation coefficient GF, the thickness d of the substrate 10 and the curvature radius r. As the aspect ratio k of the panel, the pressure variation coefficient GF and the thickness d of the substrate 10 are fixed, the voltage U across the first strain sensing resistor R₁ is directly determined by the curvature radius r. Meanwhile, the resistance value of the strain sensing resistor is in one-to-one correspondence with the strain value, and the change of the strain value can be converted into the change of the resistance value of the strain sensing resistor. The radius of curvature measuring circuit 20 outputs the voltage U across the first strain sensing resistor R₁ and the radius of curvature of the panel 200 when it is pressed can be accordingly obtained. In one embodiment, referring to FIG. 1 to FIG. 3, two resistors of the curvature radius measuring circuit 20 coincide with each other in the thickness direction of the substrate 10, or two resistors of the curvature radius measuring circuit 20 are staggeredly distributed. The expression that the resistors are staggeredly distributed means that within a certain range, the curvature radii at the two staggered resistors are close and can be approximated as the same. The circuits in above two solutions can be easily processed and assembled and be selected as needed. A position of the first strain sensing resistor R₁ of the curvature radius measuring circuit 20 serves as a measuring point of the curvature radius.

In one embodiment, the number of the curvature radius measuring circuits 20 is at least two, and the curvature radius measuring circuits 20 are distributed in an array on the substrate 10, or the number of the curvature radius measuring circuits 20 is at least two, and the curvature radius measuring circuits are distributed in a circular shape on the substrate 10. In both of the above solutions, when the pressure is applied to a plurality of positions of the panel 200, the strain sensing resistors follow the bending deformation of the panel 200 to generate measurement signals, and the strain values of the panel 200 is measured. The number of bridge circuits can vary depending on the physical size of the panel 200. The position of the plurality of curvature radius measuring circuits 20 can be set as required. It should be understood that the number of the curvature radius measuring circuits 20 is at least two, and the curvature radius measuring circuits 20 are distributed on the substrate 10 in a predetermined shape which may be a triangle, a rectangle or the like. The curvature radius measuring circuits 20 can be arranged on the substrate 10 in various ways to detect the deformation curvature radii of the panel 200 at different positions. In some arrangements, the deformation curvature radii of each position of the entire panel 200 can be approximately measured.

In one embodiment, the substrate 10 has a thickness ranging from 0.03 mm to 5 mm. Preferably, the thickness of the substrate 10 ranges from 0.1 mm to 3 mm. Thus, the curvature radius measurer 100 is thin and suitable for electronic products such as mobile phones and computers with high thickness requirements.

In one embodiment, the thickness of each resistor ranges from 3 um to 20 um. Thus, the curvature radius measurer 100 is thin and suitable for electronic products such as mobile phones and computers with high thickness requirements.

In one embodiment, the substrate 10 includes a base and a circuit layer disposed on the base. The circuit layer is used to connect the strain sensing resistors to form a complete circuit to achieve predetermined circuit functions. The circuit layer may be a circuit layer formed by printing or coating.

In one embodiment, the base is a plastic base, a glass base, a metal base or a composite base. For example, the base is PI film (polyimide film), PET film (high temperature resistant polyester film) or fiberglass board. The base can be equipped with strain sensing resistors. It should be understood that the base may alternately be made of other material. Alternatively, the substrate 10 is a flexible circuit board with its own circuits. The substrate 10 is a soft board or a hard board.

In one embodiment, the resistor is a resistor formed by printing, a resistor formed by coating, or a resistor formed by printing and having a polymer coating with pressure sensing property or a sintered piezoelectric ceramic coating. The resistances of all of the above resistors may be change according to the deformation or all of the above resistors may function as a reference resistor.

Referring to FIG. 7, a curvature radius measurer according to a second embodiment of the present disclosure is basically the same as the curvature radius measurer according to the first embodiment. Unlike the first embodiment, the curvature radius measuring circuit 20 in the second embodiment has two resistors and the curvature radius measuring circuit 20 is a shunt circuit formed by a first strain sensing resistor R₁ and a second strain sensing resistor R₂ connected in parallel.

The panel is simplified as a one-dimensional beam structure. A shunt circuit is formed and a constant current source is used. The inputs current I₀ is applied across the circuit, and the current I₂ flowing through the second strain sensing resistor R₂ is measured. Below is input and output current formula.

$${I}_{2} = \frac{{R}_{1}}{{R}_{1} + {R}_{2}} {I}_{0} = \frac{1}{2 + \frac{d}{r} GF} {I}_{0}$$

The reasoning process can refer to the first embodiment.

The rigidity of the glue has no influence on the current I₂ flowing through the second strain sensing resistor R₂, so the current I₂ flowing through the second strain sensing resistor R₂ is determined only by the pressure variation coefficient GF, the thickness d of the substrate and the curvature radius r. As the pressure variation coefficient GF and the thickness d of the substrate 10 are fixed, the current I₂ flowing through the second strain sensing resistor R₂ is directly determined by the curvature radius r. Meanwhile, the resistance value of the strain sensing resistor is in one-to-one correspondence with the strain value, and the change of the strain value can be converted into the change of the resistance value of the strain sensing resistor. The curvature radius measuring circuit 20 outputs the current I₂ flowing through the second strain sensing resistor R₂ and the curvature radius of the panel 200 when it is pressed can be accordingly obtained.

Referring to FIG. 8, a curvature radius measurer according to a third embodiment of the present disclosure is basically the same as the curvature radius measurer according to the first embodiment. Unlike the first embodiment, the curvature radius measuring circuit 20 in the third embodiment has two resistors and the curvature radius measuring circuit 20 is a series-connected constant current circuit formed by a first strain sensing resistor R1 and a second strain sensing resistor R2 connected in series.

The panel is simplified as a one-dimensional beam structure. Taking the first case as an example, the curvature radius measurer is connected with the panel by hard glue (i.e., fully rigid glue). When the panel is pressed, the substrate is deformed following the deformation of the panel. The first strain sensing resistor R₁ may represent the strain value of the first mounting surface, and the second strain sensing resistor R₂ may represent the strain value of the second mounting surface. The thickness of the glue is ignored, and the deformation neutral line is on the panel.

A series-connected constant current circuit is formed and a constant current source is used. The current I₀ is input into the circuit, and the difference between the voltage U₂ across the second strain sensing resistor R₂ and the voltage U₁ across the first strain sensing resistor R₁ is measured. Below is output voltage difference formula.

$$\begin{matrix}Δ U = {U}_{2} - {U}_{1} = {I}_{0} ( {R}_{2} - {R}_{1} ) = {I}_{0} [ {R}_{0} ( 1 + {ɛ}_{2} GF ) - {R}_{0} ( 1 + {ɛ}_{1} GF ) ] \\ = {I}_{0} {R}_{0} ( {ɛ}_{2} - {ɛ}_{1} ) GF = {I}_{0} {R}_{0} ( \frac{{t}_{2}}{r} - \frac{{t}_{1}}{r} ) GF = {I}_{0} {R}_{0} \frac{d}{r} GF\end{matrix}$$

The second case, the third case, and the reasoning process of considering panel as a two-dimensional planar structure may refer to the first embodiment.

The rigidity of the glue has no influence on the voltage difference value ΔU, so the voltage difference value ΔU is determined only by the pressure variation coefficient GF, the thickness d of the substrate and the curvature radius r. As the pressure variation coefficient GF and the thickness d of the substrate 10 are fixed, the voltage difference value ΔU is directly determined by the curvature radius r. Meanwhile, the resistance value of the strain sensing resistor is in one-to-one correspondence with the strain value, and the change of the strain value can be converted into the change of the resistance value of the strain sensing resistor. The curvature radius measuring circuit 20 outputs the voltage difference value ΔU and the curvature radius of the panel 200 when it is pressed can be accordingly obtained.

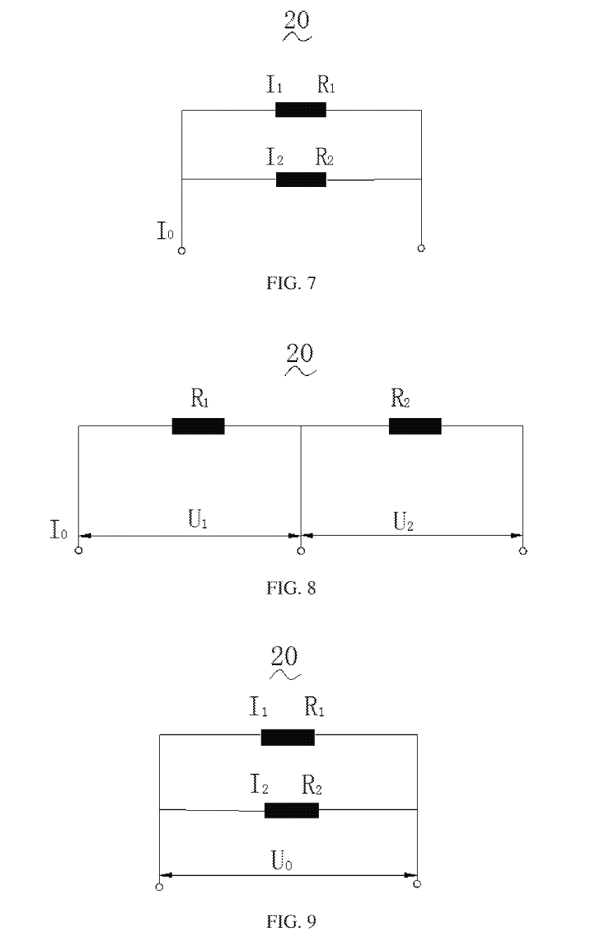

Referring to FIG. 9, a curvature radius measurer according to a fourth embodiment of the present disclosure is basically the same as the curvature radius measurer according to the first embodiment. Unlike the first embodiment, the curvature radius measuring circuit 20 has two resistors and the curvature radius measuring circuit 20 is a parallel-connected constant voltage circuit formed by a first strain sensing resistor R₁ and a second strain sensing resistor R₂ connected in parallel.

The panel is simplified as a one-dimensional beam structure. Taking the first case as an example, the curvature radius measurer is connected with the panel by hard glue (i.e., fully rigid glue). When the panel is pressed, the substrate is deformed following the deformation of the panel. The first strain sensing resistor R₁ may represent the strain value of the first mounting surface, and the second strain sensing resistor R₂ may represent the strain value of the second mounting surface.

The thickness of the glue is ignored, and the deformation neutral line is on the panel. 10o A parallel-connected constant voltage circuit is formed and a constant voltage source is used. The input voltage U₀ is applied across the circuit, and the current I₁ flowing through the first strain sensing resistor R₁ and the current I₂ flowing through the second strain sensing resistor R₂ are measured to calculate their ratio. Below is the current ratio formula.

$$Δ I = {I}_{1} \text{/} {I}_{2} = \frac{{U}_{0} \text{/} {R}_{1}}{{U}_{0} \text{/} {R}_{2}} = \frac{{R}_{2}}{{R}_{1}} = \frac{{R}_{0} ( 1 + {ɛ}_{2} GF )}{{R}_{0} ( 1 + {ɛ}_{1} GF )} = \frac{1 + \frac{{t}_{2}}{r} GF}{1 + \frac{{t}_{1}}{r} GF} = \frac{r + {t}_{2} GF}{r + {t}_{1} GF}$$

$$also ∵ {t}_{2} - {t}_{1} = d \\ ∴ Δ I = \frac{r + {t}_{2} GF}{r + {t}_{1} GF} = \frac{r + {t}_{1} GF + dGF}{r + {t}_{1} GF} = 1 + \frac{d}{\frac{r}{GF} + {t}_{1}} \\ ∵ {t}_{1} << \frac{r}{GF} ∴ \frac{d}{\frac{r}{GF} + {t}_{1}} \approx \frac{d}{r} GF \\ ∴ Δ I \approx 1 + \frac{d}{r} GF$$

Therefore, the current ratio ΔI is directly determined by the curvature radius r at the first strain sensing resistor R₁. When the panel 200 is pressed, the curvature radius measuring circuit 20 obtains the current ratio ΔI and the curvature radius r at the first strain sensing resistor R₁ can be accordingly determined.

The second case, the third case, and the reasoning process of considering the panel as a two-dimensional planar structure may refer to the first embodiment. The rigidity of the glue is between the hard glue in the first case and the soft glue in the second case. The rigidity of the glue determines the position of the deformed neutral line, and thus determines t₁ and t₂. The current ratios ΔI in the first case and the second case are the same, that is, the rigidity of the glue has no influence on the current ratio ΔI, so the current ratio ΔI is determined only by the pressure coefficient GF, the substrate thickness d and the curvature radius r, and the pressure variation coefficient GF, the thickness d of the substrate 10 and the curvature radius r. As the pressure variation coefficient GF and the thickness d of the substrate 10 are fixed, the current ratio ΔI is directly determined by the curvature radius r. Meanwhile, the resistance value of the strain sensing resistor is in one-to-one correspondence with the strain value, and the change of the strain value can be converted into the change of the resistance value of the strain sensing resistor. The curvature radius measuring circuit 20 outputs the current ratio ΔI and the curvature radius of the panel 200 when it is pressed can be accordingly obtained.

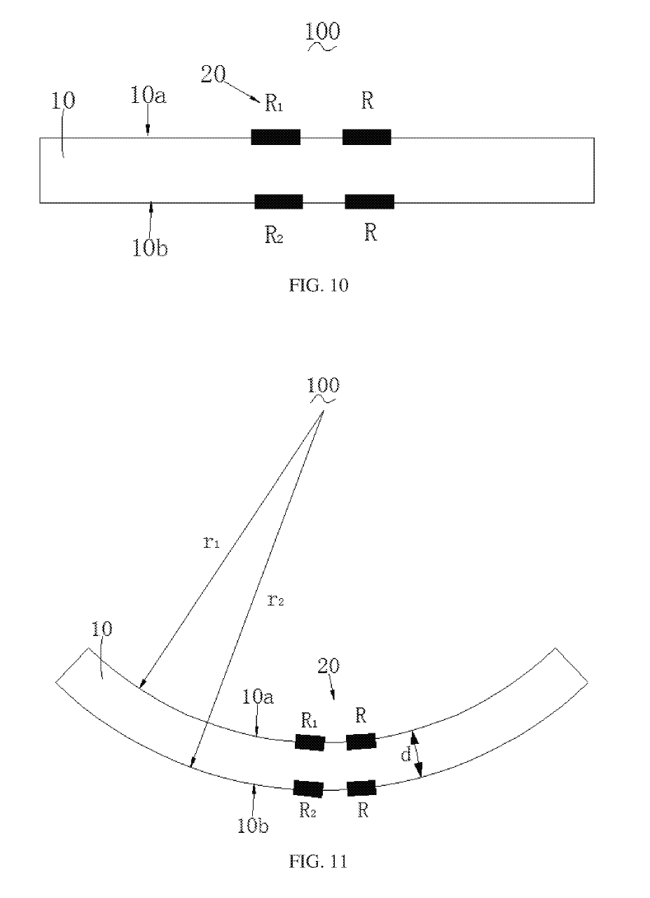

Referring to FIG. 10 to FIG. 12, the curvature radius measurer according to the fifth embodiment of the present disclosure is basically the same as the curvature radius measurer according to the first embodiment. Different from the first embodiment, the curvature radius measuring circuit 20 according to the fifth embodiment has four resistors and the curvature radius measuring circuit 20 is a half bridge circuit formed by electrically connecting a first strain sensing resistor R₁ and a second strain sensing resistor R₂ to two reference resistors R.

The panel is simplified as a one-dimensional beam structure, and a half bridge circuit is formed. An input voltage U₀ is applied across the circuit. A reference point is formed between the first strain sensing resistor R₁ and the second strain sensing resistor R₂, another reference point is formed between the two reference resistors R, and the output voltage U between the two reference points is measured.

The following are known:

$${E}_{1} = \frac{{R}_{1}}{{R}_{1} + {R}_{2}} {U}_{o}$$

$${E}_{2} = \frac{1}{2} {U}_{o}$$

Below is input and output voltage formula.

$$U = {E}_{1} - {E}_{2} = ( \frac{1}{2 + \frac{d}{r} GF} - \frac{1}{2} ) {U}_{o}$$

The reasoning process of simplifying the panel as a one-dimensional beam structure and considering the panel as a two-dimensional planar structure may refer to the first embodiment.

The rigidity of the glue has no influence on the output voltage U, so the output voltage U is determined only by the pressure variation coefficient GF, the thickness d of the substrate and the curvature radius r. As the pressure variation coefficient GF and the thickness d of the substrate 10 are fixed, the output voltage U is directly determined by the curvature radius r. Meanwhile, the resistance value of the strain sensing resistor is in one-to-one correspondence with the strain value, and the change of the strain value can be converted into the change of the resistance value of the strain sensing resistor. The curvature radius measuring circuit 20 outputs the output voltage U and the curvature radius of the panel 200 when it is pressed can be accordingly obtained.

In one embodiment, two of the four resistors of the curvature radius measuring circuit coincide with the other two of the four resistors in a one-to-one correspondence in the thickness direction of the substrate, or the four resistors of the curvature radius measuring circuit are staggeredly distributed. The expression that the resistors are staggeredly distributed means that within a certain range, the curvature radii at the two staggered resistors are close and can be approximated as the same. The circuits in above two solutions can be easily processed and assembled and be selected as needed. A position of the first strain sensing resistor R₁ of the curvature radius measuring circuit 20 serves as a measuring point of one curvature radius.

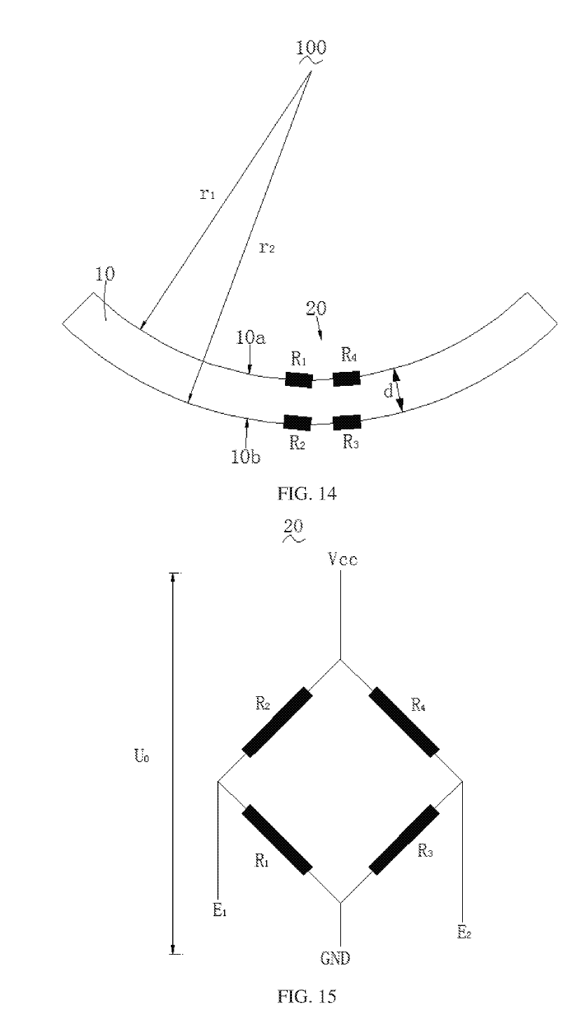

Referring to FIG. 13 to FIG. 15, the curvature radius measurer according to the sixth embodiment of the present disclosure is basically the same as the curvature radius measurer according to the fifth embodiment. Different from the fifth embodiment, the curvature radius measuring circuit 20 in the sixth embodiment is provided with four resistors and includes a third strain sensing resistor R₃ disposed on the second mounting surface 10b and configured to measure the strain value of the second mounting surface 10b and a fourth strain sensing resistor R₄ disposed on the first mounting surface 10a and configured to measure the strain value of the first mounting surface 10a. The curvature radius measuring circuit 20 is a full bridge circuit formed by a first strain sensing resistor R₁, a second strain sensing resistor R₂, a third strain sensing resistor R₃ and a fourth strain sensing resistor R₄ which are electrically connected.

Specifically, the first strain sensing resistor R₁ and the fourth strain sensing resistor R₄ are arranged in a pair of opposite bridge arms, and the second strain sensing resistor R₂ and the third strain sensing resistor R₃ are arranged in the other pair of opposite bridge arms. And the four resistors satisfy the relationship R₁R₄=R₂R₃.

The panel is simplified as a one-dimensional beam structure, and a full bridge circuit is formed. The input voltage U₀ is applied across the circuit. A reference point is formed between the first strain sensing resistor R₁ and the second strain sensing resistor R₂, another reference point is formed between the two reference resistors R, and the output voltage U between the two reference points is measured.

The following are known:

$${E}_{1} = \frac{{R}_{1}}{{R}_{1} + {R}_{2}} {U}_{o}$$

$${E}_{2} = \frac{{R}_{3}}{{R}_{3} + {R}_{4}} {U}_{o} = \frac{{R}_{2}}{{R}_{1} + {R}_{2}} {U}_{o}$$

Below is input and output voltage formula.

$$U = {E}_{1} - {E}_{2} = [ \frac{1}{2 + \frac{d}{r} GF} - ( 1 - \frac{1}{2 + \frac{d}{r} GF} ) ] {U}_{0} = [ \frac{2}{2 + \frac{d}{r} GF} - 1 ] {U}_{o}$$

The reasoning process of simplifying the panel into a one-dimensional beam structure and considering the panel as a two-dimensional planar structure can be referred to the first embodiment.

The rigidity of the glue has no influence on the output voltage U, so the output voltage U is determined only by the pressure variation coefficient GF, the thickness d of the substrate and the curvature radius r. As the pressure variation coefficient GF and the thickness d of the substrate 10 are fixed, the output voltage U is directly determined by the curvature radius r. Meanwhile, the resistance value of the strain sensing resistor is in one-to-one correspondence with the strain value, and the change of the strain value can be converted into the change of the resistance value of the strain sensing resistor. The curvature radius measuring circuit 20 outputs the output voltage U and the curvature radius of the panel 200 when it is pressed can be accordingly obtained.

It should be understood that the curvature radius measuring circuit 20 may alternatively be other known circuits.

Referring to FIG. 1 to FIG. 5, an electronic device according to an embodiment of the present disclosure includes a panel 200, a curvature radius measurer 100, and a curvature radius detecting circuit electrically connected to the curvature radius measurer 100. The substrate 10 is adhered to the panel 200.

The curvature radius measurer 100 is in the form of a film or a plate. The curvature radius measurer 100 is stacked with the panel 200. The structure is compact and the assembly is easy. The curvature radius detecting circuit analyzes and processes the electrical signal of the curvature radius measurer 100 and transmits the processed electrical signal to the controller of the electronic device so as to realize the measurement of the curvature radius of the panel 200.

Panel 200 may be a touch screen, display, or other electronic device having a rigid structure. By connecting the curvature radius measurer 100 to the panel 200, it is possible to accurately detect the curvature radius of the panel 200 when pressed, thereby expanding application space for product applications, human-computer interaction, and consumer experience for electronic devices. A precise curvature radius can be directly obtained by touching the touch screen, display or electronic device by user.

Specifically, the panel 200 may be a glass plate having a thickness of 1.1 mm, and the glass plate itself is provided with a function of a touch screen, or the panel 200 may be an LCD or OLED display screen with a thickness of 1.6 mm, or the panel 200 may be an electronic component having touch and display functions.

The curvature radius detecting circuit is configured to detect an electrical signal obtained by the curvature radius measurer 100, process and analyze the electrical signal. The curvature radius measurer 100 is connected to the curvature radius detecting circuit through connecting wires, which is one of the possible ways connecting the curvature radius measurer 100 with the curvature radius detecting circuit. In other embodiments, the curvature radius measurer 100 may be directly or indirectly connected with the detecting circuit through other ways.

In one embodiment, the entire surface of the substrate 10 is connected to the panel 200. In this solution, when the panel 200 is pressed, the panel 200 will be bent and deformed to cause corresponding deformation of the strain sensing resistors. The curvature radius measuring circuit 20 converts the deformation into an electrical signal and then outputs the electrical signal.

The curvature radius measurer 100 is adhered to the panel 200. When the panel 200 is pressed, the panel 200 is bent and deformed, and the strain sensing resistors deform following the deformation of the panel, thereby causing the change of the electrical characteristics of the curvature radius measuring circuit 20. The electrical characteristics are only related to the curvature radius of the panel 200. The curvature radius of the panel 200 at the pressed position can be accurately detected by obtaining the corresponding electrical signal through the curvature radius measurement circuit 20. The curvature radius measurer 100 can be easily manufactured and assembled, the inconvenient use caused due to the need to place the object to be measured on the existing optical measuring instrument can be avoided, and the interference caused by different adhesive conditions can be avoided. Therefore, the curvature radius measure has good stability and repeatability. When the curvature radius of the panel 200 is far greater than the thickness of the substrate, the detection is reliable and the thickness of the substrate can be as small as 0.1 mm. In some cases of micro-deformation, the curvature radius of the panel 200 is generally greater than 1000 mm, so the curvature radius measurer 100 is very suitable for detecting micro-deformation. The curvature radius measurer is small in thickness, is suitable for mobile phones, computers and other electronic products with high thickness requirements and is used as a pressure sensing sensor. It is also suitable for household appliances and is used as a pressure button. It is also applicable to any panel 200 having a curvature change and is used to detect changes in the curvature radius of the panel 200 or to detect changes in the cause of changes in the curvature radius.

In one embodiment, the substrate 10 and the panel 200 are adhered to each other by glue. By this configuration, the assembly is easy, the connection between the substrate 10 and the panel 200 is firm and the deformation can be transmitted. It can be understood that the curvature radius measurer 100 is adhered to the panel 200, and the curvature radius measurer 100 and the panel 200 may be connected to each other by other mechanical means such as glue, a fastener, a snap-fit structure, and the like. In each case, the curvature radius of the panel 200 when pressed can be directly measured using the curvature radius measurer 100.

In one embodiment, the glue only need to ensure tight connection in the radial direction, and do not require tight connection in the tangential direction. The glue may be UV glue, AB glue, 502 glue, double-sided glue, foam glue or other hard glue or soft glue. The material selection and thickness of the materials are determined according to the materials of the substrate 10 and the panel 200.

Referring to FIG. 1 to FIG. 5, a method for manufacturing a curvature radius measurer 100 according to an embodiment of the present disclosure includes the steps S₁ to S₃.

In S₁, a substrate 10 is provided.

In S₂, at least two resistors are formed on the substrate 10, at least one of the resistors being the first strain sensing resistor R₁ disposed on the first mounting surface 10a and at least one of the resistors being the second strain sensing resistor R₂ disposed on the second mounting surface 10b.

In S₃, the resistors are electrically connected to form a curvature radius measuring circuit 20.

The curvature radius measurer 100 is adhered to the panel 200. When the panel 200 is pressed, the panel 200 is bent and deformed, and the strain sensing resistors deform following the deformation of the panel, thereby causing the change of the electrical characteristics of the curvature radius measuring circuit 20. The electrical characteristics are directly determined by the curvature radius of the panel 200. The curvature radius of the panel 200 at the pressed position can be accurately detected by obtaining the corresponding electrical signal through the curvature radius measurement circuit 20. The curvature radius measurer 100 can be easily manufactured and assembled, the inconvenient use caused due to the need to place the object to be measured on the existing optical measuring instrument can be avoided, and the interference caused by different adhesive conditions can be avoided. Therefore, the curvature radius measure has good stability and repeatability. When the curvature radius of the panel 200 is far greater than the thickness of the substrate, the detection is reliable and the thickness of the substrate can be as small as 0.1 mm. In some cases of micro-deformation, the curvature radius of the panel 200 is generally greater than 1000 mm, so the curvature radius measurer 100 is very suitable for detecting micro-deformation. The curvature radius measurer is small in thickness, is suitable for mobile phones, computers and other electronic products with high thickness requirements and is used as a pressure sensing sensor. It is also suitable for household appliances and is used as a pressure button. It is also applicable to any panel 200 having a curvature change and is used to detect changes in the curvature radius of the panel 200 or to detect changes in the cause of changes in the curvature radius.

In one embodiment, referring to FIG. 6, a first strain sensing resistor R₁ and a second strain sensing resistor R₂ are connected in series to form a voltage dividing circuit as the curvature radius measuring circuit 20.

Or, referring to FIG. 7, a first strain sensing resistor R₁ and a second strain sensing resistor R₂ are connected in parallel to form a shunt circuit which functions as a curvature radius measuring circuit 20.

Or, referring to FIG. 8, a first strain sensing resistor R₁ and a second strain sensing resistor R₂ are connected in series to form a series-connected constant current circuit which functions as a curvature radius measuring circuit 20.

Or, referring to FIG. 9, a first strain sensing resistor R₁ and a second strain sensing resistor R₂ are connected in parallel to form a parallel-connected constant voltage circuit which functions as a curvature radius measuring circuit 20.

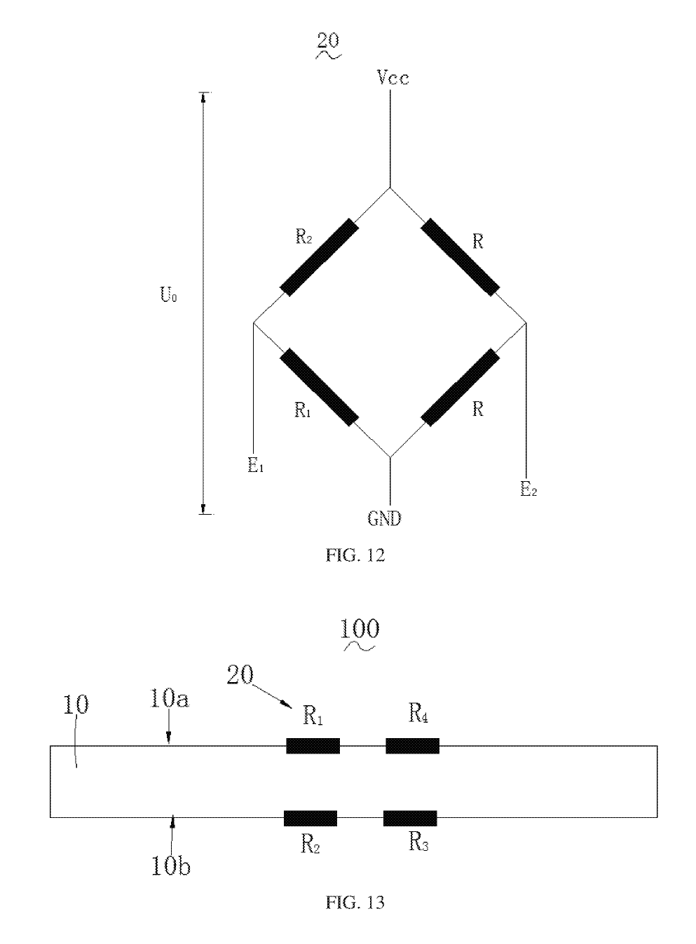

Or, referring to FIG. 12, a first strain sensing resistor R₁, a second strain sensing resistor R₂ and two reference resistors R are electrically connected to form a half bridge circuit which functions as a curvature radius measuring circuit 20.

Or, referring to FIG. 15, a third strain sensing resistor R₃ is formed on the second mounting surface 10b, and a fourth strain sensing resistor R₄ is formed on the first mounting surface 10a. A first strain sensing resistor R₁, a second strain sensing resistor R₂, a third strain sensing resistor R₃ and a fourth strain sensing resistor R₄ are electrically connected to form a full bridge circuit which functions as the curvature radius measuring circuit 20.

In the above solutions, when the panel 200 is pressed, the strain sensing resistors follow the bending deformation of the panel 200 to generate measurement signals and the curvature radius of the panel 200 can be measured. The curvature radius measurers according to the first to sixth embodiments of the present disclosure may be referred to.

The above content is only the preferred embodiments of the present disclosure, and is not intended to limit the present disclosure. Any modifications, equivalents, and improvements made within the spirit and scope of the present disclosure should be included in the scope of the present disclosure.

What is claimed is:

1. A curvature radius measurer, comprising:
a substrate adhered to a panel, the substrate having a first mounting surface and a second mounting surface disposed opposite to each other,
a curvature radius measuring circuit disposed on the substrate, the curvature radius measuring circuit comprising at least two resistors formed on the substrate,
at least one of the at least two resistors comprising a first strain sensing resistor disposed on the first mounting surface and configured to measure the strain value of the first mounting surface,
at least another of the at least two resistors comprising a second strain sensing resistor disposed on the second mounting surface and configured to measure the strain value of the second mounting surface,
wherein the resistors of the curvature radius measuring circuit are adjacently distributed.

2. The curvature radius measurer according to claim 1, wherein:
said curvature radius measuring circuit comprising at least two resistors comprises a voltage dividing circuit formed by said first strain sensing resistor and said second strain sensing resistor connected in series; or
said curvature radius measuring circuit comprising at least two resistors is a shunt circuit formed by said first strain sensing resistor and said second strain sensing resistor connected in parallel; or
said curvature radius measuring circuit comprising at least two resistors is a series-connected constant current circuit formed by one said first strain sensing resistor and one said second strain sensing resistor connected in series; or
said curvature radius measuring circuit comprising at least two resistors is a parallel-connected constant voltage circuit formed by said first strain sensing resistor and said second strain sensing resistor connected in parallel.

3. The curvature radius measurer according to claim 2, wherein two of the resistors of said curvature radius measuring circuit are placed coincident with each other across the thickness of the substrate; or
two of the resistors of said curvature radius measuring circuit are staggeredly placed.

4. The curvature radius measurer according to claim 1, wherein said curvature radius measuring circuit comprises four resistors and is a half bridge circuit formed by said first strain sensing resistor, said second strain sensing resistor and two reference resistors which are electrically connected; or
said curvature radius measurer comprises four resistors and includes a third strain sensing resistor disposed on the second mounting surface and configured to measure the strain value of the second mounting surface and a fourth strain sensing resistor disposed on the first mounting surface and configured to measure the strain value of the first mounting surface,
wherein the curvature radius measuring circuit is a full bridge circuit formed by said first strain sensing resistor, said second strain sensing resistor, said third strain sensing resistor and said fourth strain sensing resistor which are electrically connected.

5. The curvature radius measurer according to claim 4, wherein two of the four resistors of said curvature radius measuring circuit coincident with the other two of the four resistors are placed in a one-to-one correspondence across the thickness of the substrate; or
the four resistors of said curvature radius measuring circuit are staggeredly placed.

6. The curvature radius measurer according to claim 1, wherein the curvature radius measurer comprises at least two said curvature radius measuring circuits which are distributed in an array on the substrate; or
the curvature radius measurer comprises at least two said curvature radius measuring circuits which are distributed in a circular shape on the substrate.

7. The curvature radius measurer according to claim 1, wherein the substrate has a thickness ranging from 0.03 mm to 5 mm.

8. The curvature radius measurer according to claim 1, wherein the substrate comprises a base and a circuit layer disposed on the base.

9. The curvature radius measurer according to claim 8, wherein the base is a plastic base, a glass base, a metal base or a composite base.

10. The curvature radius measurer according to claim 1, wherein the resistors are formed by printing, by coating, or by printing and having a polymer coating with pressure sensing property or a sintered piezoelectric ceramic coating.

11. An electronic device, comprising:
a panel,
a curvature radius measurer of claim 1, and
a curvature radius detecting circuit electrically connected to the curvature radius measurer,
wherein the substrate is adhered on the panel.

12. The electronic device according to claim 11, wherein the substrate and the panel are adhered to each other by glue.

13. The electronic device according to claim 12, wherein the glue is UV glue, AB glue, 502 glue, double-sided glue or foam glue.

14. A method of manufacturing a curvature radius measurer of claim 1, comprising the steps of:
S₁) providing the substrate;
S₂) forming at least two resistors on the substrate, at least one of the resistors being the first strain sensing resistor disposed on the first mounting surface and at least one of the resistors being the second strain sensing resistor disposed on the second mounting surface; and
S₃) electrically connecting the resistors to form a curvature radius measuring circuit.

15. The method of manufacturing a curvature radius measurer according to claim 14, wherein the a curvature radius measuring circuit is formed as a voltage dividing circuit by connecting one said first strain sensing resistor in series with one said second strain sensing resistor; or
the curvature radius measuring circuit is formed as a shunt circuit by connecting one said first strain sensing resistor in parallel with one said second strain sensing resistor; or
the curvature radius measuring circuit is formed as a series-connected constant current circuit by connecting one said first strain sensing resistor in series with one said second strain sensing resistor; or
the curvature radius measuring circuit is formed as a parallel-connected constant voltage circuit by connecting one said first strain sensing resistor in parallel with one said second strain sensing resistor; or
the curvature radius measuring circuit is formed as a half bridge circuit by electrically connecting one said first strain sensing resistors, one said second strain sensing resistor and two reference resistors; or
the method In one embodiment comprises forming a third strain sensing resistor on the second mounting surface, forming a fourth strain sensing resistor on the first mounting surface, and forming the curvature radius measuring circuit as a full bridge circuit by electrically connecting one said first strain sensing resistor, one said second strain sensing resistor, one said third strain sensing resistor and one said fourth strain sensing resistor.
